(19) United States
(12) Patent Application Publication
(10) Pub. No.: US 2007/0231116 A1
(43) Pub. Date: Oct. 4, 2007

(54) Pallet keeper

(76) Inventor: Thomas Terrence Kimener, Loveland, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/714,703

(22) Filed: Mar. 6, 2007

Related U.S. Application Data
(60) Provisional application No. 60/779,575, filed on Mar. 6, 2006.

(51) Int. Cl. A01D 90/08

(52) U.S. Cl. 414/802

(57) ABSTRACT

A pallet cuber for vertically aligning and stacking empty pallets comprising: (a) a primary guide extending vertically and horizontally in a first X-Y plane comprising an X-axis and a Y-axis, the primary guide vertically extending at least to a height of four flat lying pallets stacked upon one another; and (b) a barrier extending vertically and lengthwise in a Y-Z plane, comprising a Z-axis and the Y-axis, that is perpendicular to the first X-Y plane, the barrier being spaced apart from the primary guide a distance less than a length of a pallet and vertically extending at least to the height of four flat lying pallets stacked upon one another, the barrier being repositionable between a retaining position and an egress position, wherein the retaining position inhibits a pallet from traveling beyond the barrier while traveling along the primary guide in a first direction along the X axis in an X-Z plane, and wherein the egress position allows the pallet to travel beyond the barrier while traveling along the primary guide in the first direction.

### CROSS REFERENCE TO RELATED APPLICATIONS

The present application claims the benefit of U.S. Provisional Patent Application Ser. No. 60/779,575, filed Mar. 6, 2006, the disclosure of which is hereby incorporated by reference.

### FIELD OF THE INVENTION

The present invention is directed to devices and methods for organizing empty pallets used in shipping goods and, more specifically, to devices and methods for economically and efficiently stacking empty pallets.

Storage facilities and large retail establishments utilize semi tractor trailers to receive a majority of their inventory. To accommodate for the relatively large volume of goods needing to be offloaded or loaded in a relatively short period of time, as well as the size of certain goods, machinery and packaging have been devised to hasten the process. The most common form of machinery for loading and unloading goods is a forklift. Forklifts take advantage of relatively uniform platforms upon which the goods are mounted to allow large, heavy, and numerous goods to be moved in short order. These uniform platforms are commonly referred to as pallets. Pallets are most commonly wooden, however, other materials may be used to construct pallets such as plastics and metals.

Goods may be manually or automatically removed from the pallets, or may be stored on the pallets themselves. For example, machines have also been developed to automatically extract the goods from the pallet. In most instances, however, the goods are stored on the pallets to ensure that eventual consumption or repositioning remains relatively easy. Most industrial warehouses include shelving that accommodates bulk storage of goods so that the goods remain on the pallets. However, at some point the goods are removed from the pallets for consumption purposes. An example would be a pallet of auto parts that are utilized by an automaker in assembling an automobile.

Generally, the empty pallets are loosely stacked or thrown into a disorganized pile. More infrequently, pallets are manually stacked using a forklift as a backstop or simply stacked on the floor. In both cases, the resulting stacks are hastily constructed and most often not aligned. Thus, when the forklift picks up the stack of empty pallets to move them to another area, the unorganized alignment renders the stack unstable and susceptible to toppling over and injuring adjacent workers.

### INTRODUCTION TO THE INVENTION

The present invention is directed to devices and methods for organizing empty pallets, such as those used in shipping goods and, more specifically, to devices and methods for economically and efficiently stacking empty pallets prior to a subsequent use.

The present invention, in exemplary form, includes two frame members straddling a,conveyor upon which empty pallets are to be stacked. A third frame member is positioned on the same side of the conveyor and cooperates with the first frame member to define a plane against which pallets are positioned. A gate is mounted to the first frame member and selectively inhibits the stacked or unstacked pallets from egressing from the keeper and cooperates with the first and third frame members to define a block U-shaped cavity into which pallets are positioned. The vertical nature of the block U-shaped cavity ensures that as successive pallets are stacked on top of one another, with the stack has a whole having a uniform length and width. In this manner, the stack may be aligned prior to removal from the keeper so that the transportation of the stack is not unreasonably jeopardized by the alignment of the pallets. Moreover, the frame members are positioned in a triangular fashion to allow for loading of empty pallets from more than one side, thereby providing a greater range of movement if the pallets are stacked manually.

It is a first aspect of the present invention to provide a pallet keeper for vertically aligning and stacking empty pallets comprising: (a) a primary guide extending vertically and widthwise in an X-Y plane, the primary guide vertically extending at least the height of four flat lying pallets stacked upon one another; and (b) a barrier extending vertically and lengthwise in a Y-Z plane and downstream from the primary guide a distance less than a length of a pallet and vertically extending at least the height of four flat lying pallets stacked upon one another, the barrier being oriented between a retaining orientation and an egress orientation, where the retaining position inhibits a pallet from traveling adjacent to the primary guide and beyond a predetermined point in a first direction, and where the egress position allows the pallet to travel adjacent to the primary guide and beyond the predetermined point in the first direction.

In a more detailed embodiment of the first aspect, the primary guide includes a first guide and a second guide, where the first guide is spaced from the second guide in an X direction within the X-Y plane, and the barrier is repositionably mounted to the first guide. In yet another more detailed embodiment, the invention further comprises an actuator operative to direct the repositioning of the barrier from at least one of the retaining position to the egress position, and the egress position to the retaining position, where the barrier is at least one of slidably repositionable and rotatably repositionable with respect to the primary guide. In a further detailed embodiment, the barrier extends vertically and widthwise in the X-Y plane, and the barrier and the primary guide cooperate to provide a block U-shaped pallet receiver when the barrier is in the retaining position. In still a further detailed embodiment, the invention further comprises a secondary guide extending vertically and widthwise in the X-Y plane and spaced in a Z direction from the primary guide, where the secondary guide, barrier, and primary guide cooperate to provide a block U-shaped pallet receiver when the barrier is in the retaining position. In a more detailed embodiment, the invention further comprises a conveyor to allow the pallet to be conveyed in an X direction within an X-Z plane, where the bed of the conveyor is perpendicular to the primary guide and perpendicular to the barrier.

It is a second aspect of the present invention to provide a pallet keeper for vertically aligning and stacking empty pallets comprising: (a) a first guide including an exposed surface facing in a first direction; and (b) a barrier repositionable between a retaining position and an egress position, the barrier including a stop cooperating with the exposed surface of the first guide to provide a pallet receiver while the barrier is in the retaining position, the pallet receiver provides a backstop used to vertically align a plurality of flat-lying pallets in widthwise and lengthwise directions, where the pallet receiver is discontinued in the egress position of the barrier to permit passage of the plurality of flat-lying pallets beyond the barrier.

In a more detailed embodiment of the second aspect, the invention further comprises a conveyor, where the conveyor extends adjacent to the first guide and a bed of the conveyor is perpendicular to the stop of the barrier in the retaining position. In still another more detailed embodiment, the invention further comprises a second guide being spaced a first horizontal distance from the first guide, the second guide including a corresponding exposed surface facing in a second direction, generally opposite the first direction, the first and second guides cooperating to define an opening through which the plurality of flat-lying pallets pass when the barrier is in the egress position, where the barrier is repositionable in the first direction toward the first guide to establish the retaining position and repositionable in the second direction away from the first guide to establish the egress position. In a further detailed embodiment, the invention further comprises a supplemental guide including a surface facing in the first direction, where the surface of the supplemental guide cooperates with the exposed surface of the first guide to define a vertically oriented plane normal to a surface upon which the plurality of flat-lying pallets lie, where the first guide, the second guide, and the supplemental guide are arranged in a right triangular manner while the barrier is in the retaining position and the egress position. In still a further detailed embodiment, the barrier includes a corresponding exposed surface facing in a second direction, generally opposite the first direction, and spaced a first horizontal distance from the first guide, and the barrier is repositionable in the first direction toward the first guide to establish retaining position and repositionable in the second direction away from the first guide to establish the egress position. In a more detailed embodiment, the invention further comprises a supplemental guide including a surface facing in the first direction, where the surface of the supplemental guide cooperates with the exposed surface of the first guide to define vertically oriented plane normal to a surface upon which the plurality of flat-lying pallets lie, where the first guide, stop, and supplemental guide are arranged in a right triangular manner while the barrier is in the retaining position, and where the first guide, stop, and supplemental guide are arranged in a co-linear manner while the barrier is in the egress position.

It is a third aspect of the present invention to provide a pallet keeper comprising: (a) a first obstruction providing a normal surface closing a first side of the pallet keeper to inhibit loading of empty pallets from the first side while the pallets are lying flat; (b) a gate repositionable between a closed position and an open position, the closed position orienting the gate in a manner generally perpendicular to the normal surface of the first obstruction and closing a second side of the pallet keeper to inhibit loading empty pallets from the second side when the empty pallets are lying flat, where the pallet keeper is open on at least a third side and a fourth side to allow empty pallets to be loaded and vertically stacked, where the third side is parallel to and opposite from the first side, and where the fourth side is parallel to and opposite the fourth side.

In a more detailed embodiment of the third aspect, the invention further comprises a conveyor traversing the first guide and second guide, with a length of the conveyor running substantially adjacent to the first guide and first stop.

It is a fourth aspect of the present invention to provide a method of cubing pallets comprising: (a) positioning a pallet stacking jig in proximity to a conveyor, the pallet stacking jig including at least two barriers operative to vertically align first sides of a plurality of pallets and vertically align second sides of the plurality of pallets, where the first sides are generally perpendicular to the second sides, and where the first sides are generally uniform in length and the second sides are generally uniform in length; (b) positioning a pallet so that a first side of the pallet is substantially parallel to a first barrier of the pallet staking jig and positioning the pallet so that a second side of the pallet is substantially parallel to a first barrier of the pallet staking jig; (c) repeating the act of positioning the pallet to form the plurality of pallets; and (d) conveying the plurality of pallets downstream from the pallet staking jig.

In a more detailed embodiment of the fourth aspect, the act of positioning the pallet includes conveying the pallet along the conveyor in a first direction, and the act of conveying the plurality of pallets downstream from the pallet staking jig is in the first direction. In still another more detailed embodiment, the act of positioning the pallet includes conveying the pallet along the conveyor in a first direction, and the act of conveying the plurality of pallets downstream from the pallet staking jig is in a second direction perpendicular to the first direction.

It is a fifth aspect of the present invention to provide a pallet keeper comprising: (a) a first obstruction providing a normal surface closing a first side of the pallet keeper to inhibit loading of empty pallets from the first side while the pallets are lying flat; (b) a second obstruction mounted to the first obstruction and providing a normal surface closing a second side of the pallet keeper to inhibit loading of empty pallets from the first side while the pallets are lying flat, where the first and second obstruction cooperate to provide a pallet stack receiver that extends vertically to align a stack of pallets along at least two sides of the pallets; and (c) an upright support about which the pallet stack receiver horizontally pivots between a loading position and an unloading position.

### BRIEF DESCRIPTION OF THE DRAWINGS

FIG. 1 is an elevated perspective view from a left rear quadrant of a first exemplary pallet keeper in accordance with the present invention;

FIG. 2 is an elevated perspective view from a right rear quadrant of the exemplary pallet keeper of FIG. 1;

FIG. 3 is an elevated perspective view from a right front quadrant of the exemplary pallet keeper of FIG. 1;

FIG. 4 is an elevated perspective view from a left front quadrant of the exemplary pallet keeper of FIG. 1;

FIG. 5 is a right side profile view of the exemplary pallet keeper of FIG. 1; and

FIG. 6 is a overhead view of the exemplary pallet keeper of FIG. 1.

### DESCRIPTION OF EXEMPLARY EMBODIMENTS

The exemplary embodiments of the present invention are described and illustrated below to encompass methods of stacking empty pallets as well as devices utilized to stack such pallets. Of course, it will be apparent to those of ordinary skill in the art that the preferred embodiments discussed below are exemplary in nature and may be reconfigured without departing from the scope and spirit of the present invention. However, for clarity and precision, the exemplary embodiments as discussed below may include optional steps, methods, and features that one of ordinary skill should recognize as not being a requisite to fall within the scope of the present invention.

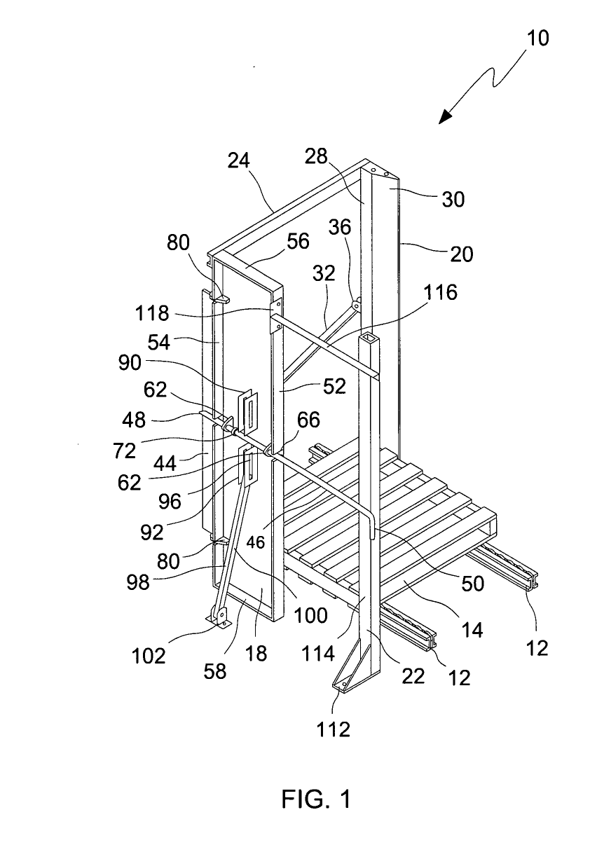

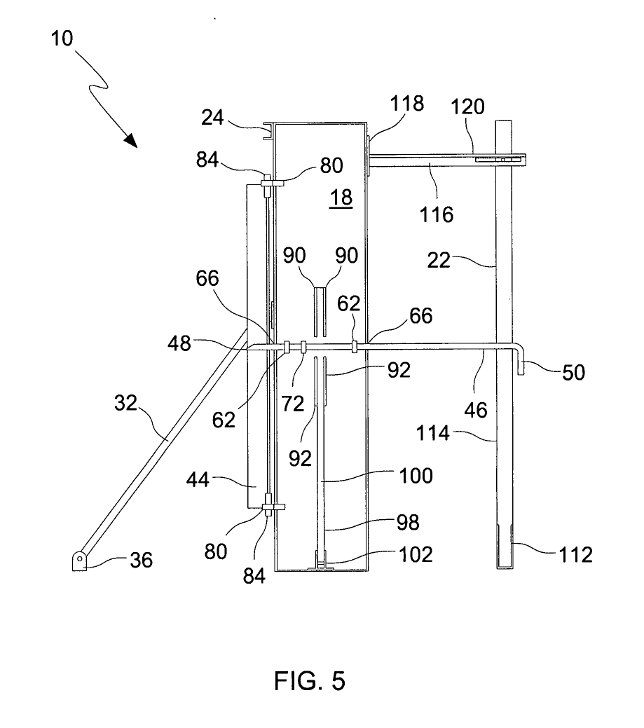

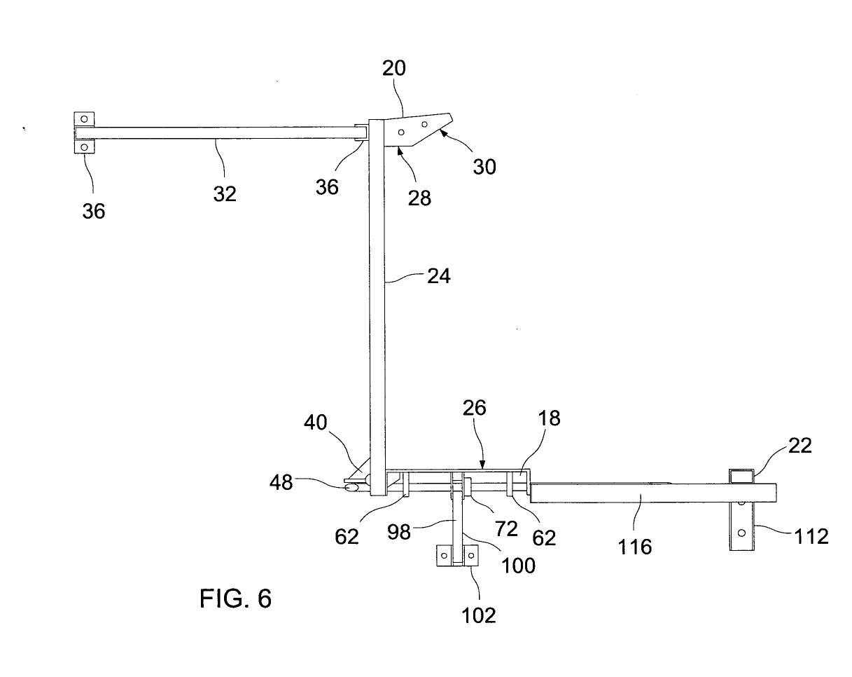

Referencing FIGS. 1-6, a first exemplary pallet keeper 10 straddles a conveyor 12 that provides an elevated platform upon which empty pallets 14 will be stacked. The pallet keeper 10 may be downstream from an automated unloading machine (not shown) that is operative to remove goods previously loaded onto the pallets 14, or may be positioned in proximity to an intermediary collection area of empty pallets 14 such as a drop off area for forklift operators where the pallets are stacked manually. In either instance, the conveyor 12 provides a means to convey a finished stack of pallets from the pallet keeper 10. In this exemplary embodiment, and for purposes of explanation only, a standard wooden pallet 14 has dimensions of 40″×48″×5″ (l×w×h). However, those of ordinary skill will readily understand that pallets having sizes other than a standard wooden pallet may be accommodated by the present invention.

The pallet keeper 10 includes three guides 18, 20, 22 that are vertically oriented and are mounted normal to the floor of a building, such as a warehouse. These guides 18, 20, 22 cooperate to facilitate the stacking of flat lying empty pallets 14 so that the widthwise and lengthwise dimensions of the pallet stack are generally uniform along the vertical planes of the stack.

The first guide 18 includes an extended backstop surface 26 spaced from the conveyor 12 so that the surface of the backstop 26 is generally perpendicular to conveyor 12. The backstop surface 26 faces the conveyor 12 and the second guide 20, which is positioned on the other side of the conveyor 12 and connected to the first guide 18 by a crossbar 24.

The second guide 20 includes two vertical surfaces 28, 30 that cooperate to align the pallets 14 when stacked one on top of another. The first vertical surface 28 runs parallel to the backstop surface 26 of the first guide 18, whereas the second vertical surface 30 is angled with respect to the backstop surface 26 so that the widthwise dimension between the backstop surface 26 and the second vertical surface 30 generally increases in the upstream direction. The tapered nature of the second guide 20 acts to direct the pallets 14 toward the backstop surface 26 of the first guide 18 as each pallet 14 is horizontally directed into contact with the second guide 20 along the line of travel of the conveyor 12. A bracing arm 32 is mounted to a rear surface 34 of the second guide 20 and the floor using a pair of brackets 36. The bracing arm 32 is adapted to retard displacement of the second guide 20 as the bracing arm 32 counteracts the forces exerted by horizontally moving pallets 14 that contact the guide 20 and would otherwise tend to displace the second guide 20 in the direction of travel of the conveyor 12.

The distance between the guides 18, 20 partially defines an opening 38 through which stacked pallets 14 may egress from the keeper 10. Spacing between the first and second guides 18, 20 may depend directly upon the dimensions of the pallets 14 to be stacked. For example, it is preferred to have the distance between the guides 18, 20 (generally between the backstop surface 26 and the first surface 28) be greater than a shorter lengthwise dimension of the pallets 14 to be stacked, but be less than a longer widthwise dimension of the pallets. In this manner, flat lying pallets 14 may pass through the opening 38 in the lengthwise direction, but not in the widthwise direction. Such a configuration would automatically inhibit the discharge of a stack of pallets 14 from the keeper 10 with the widthwise dimension embodying the leading edge of the stack. However, as will be discussed in more detail hereafter, the spacing between the first and second guides 18, 20 may be varied to accommodate for the dimensions of target pallets to be stacked.

A manually repositionable gate 40 is pivotally mounted to the first guide 18 and selectively restricts the egress of horizontally lying pallets 14 through the opening 38. The gate 40 includes a first vertical surface 42 operative to provide a stop against which pallets 14 may be positioned to vertically align the pallets. This first surface 42 cooperates with the backstop surface 26 of the first guide 18 to provide a 90° degree guide so that when the widthwise aspect of the pallet 14 is generally flush against the backstop 26 and pushed forward against the gate 40, the lengthwise aspect of the pallet 14 will correspondingly be generally flush against the vertical surface 42. In this manner, as pallets 14 are stacked upon one another and directed forward into this 90° degree guide, the lengthwise and widthwise aspects of the pallets will be aligned vertically.

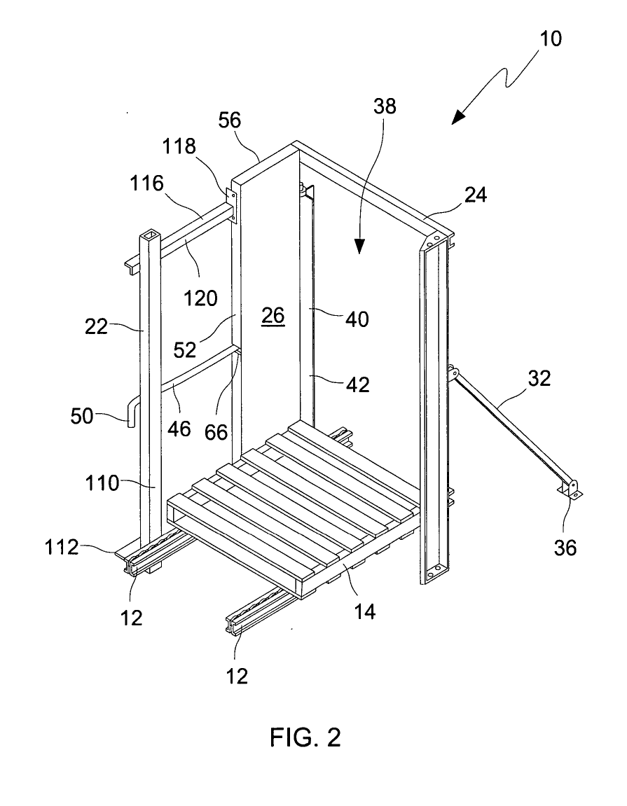

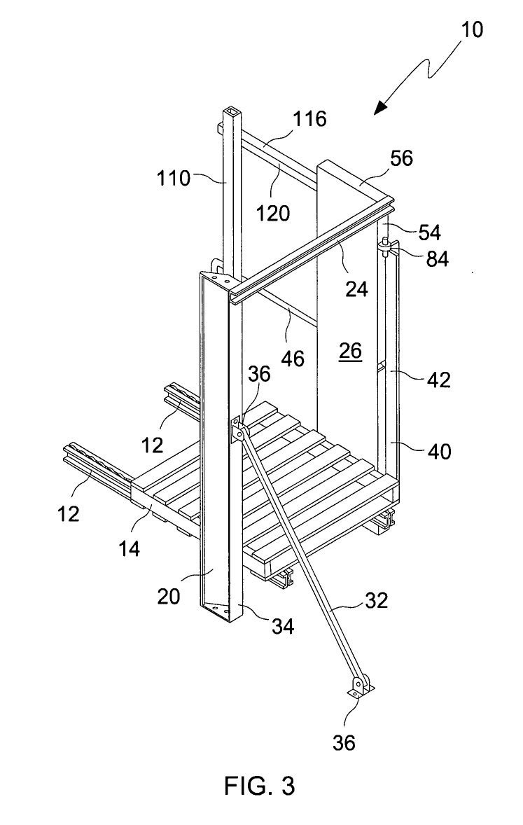

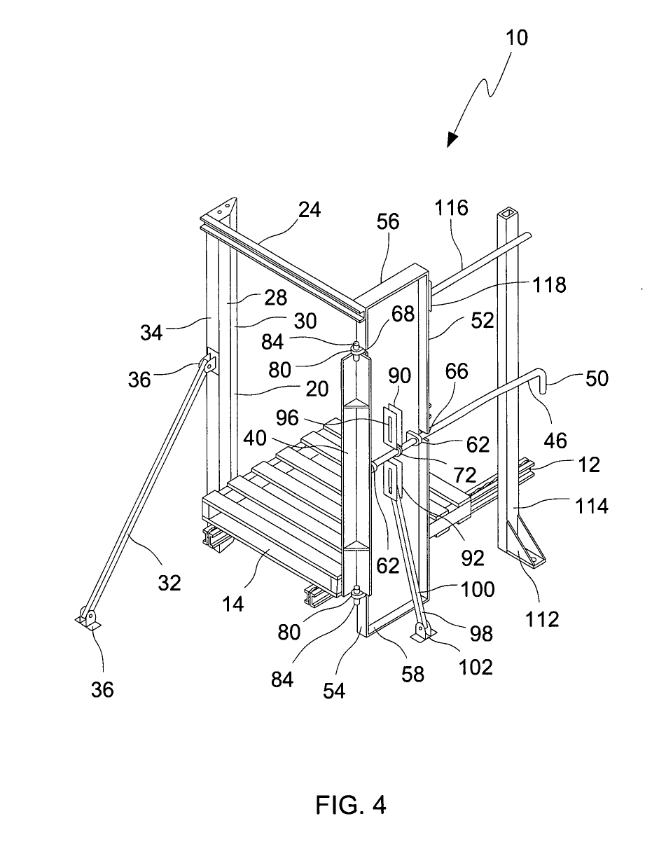

Referring to FIG. 4, the gate 40 also includes a second vertical surface 44, perpendicular to the first vertical surface 42, that is adapted to be contacted by a manual actuator 46 to reposition the gate 40 from an open position to a closed position. The actuator 46 is slidably mounted to the first guide 18 to allow horizontal traversal. A tip of an angled distal end 48 of the actuator 46 is repositioned (rotationally and horizontally) by a proximal handle 50 so that a planar surface of the angled distal end 48 faces the second vertical surface 44. As the handle 50 is moved forward, the tip of the distal end 48 contacts the second vertical surface 44 and causes the gate 40 to pivot toward the closed position (see FIGS. 3-6). Continued forward movement of the actuator 46 results in continued contact between the surface of the angled distal end 48 and the second vertical surface 44 of the gate 40 to reposition the gate 40 to the closed position. A circumferential longitudinal surface of the actuator 46 comes into contact with the second vertical surface 38 and maintains the gate 34 in the closed position as shown in FIG. 2 after the surface of the angled distal end 48 passes beyond the point of contact with the actuator 46. When a stack of pallets 14 is ready egress from the keeper 10, the actuator 46 is drawn rearward and out of the pivoting arc of travel of the gate 40. This rearward withdrawal of the actuator 46 allows the forward momentum of the pallet stack to pivot the gate 40 to the open position.

Referencing FIGS. 1-6, the third guide 22 is positioned upstream from the first and second guides 18, 20 and positioned on the same side of the conveyor 12 as the first guide 18. In an exemplary configuration, the first and third guides 18, 22 are equally backset from the conveyor 12 and cooperate to define a vertical plane perpendicular to the horizontal plane of the conveyor 12. This vertical plane is preferably normal to the floor of the building, however, deviations from completely vertical are also within the scope of the invention. An area opposite the third guide 22 directly upstream from, and on the same side of the conveyor 12 as, the second guide 20, is open and allows for loading of pallets onto the conveyor 12 in directions other than generally parallel to the line of travel of the conveyor. For instance, in embodiments where a random pile of empty pallets is adjacent to the keeper 10, a worker may pick up a pallet and pivot 180° to position the pallet 14 against one or both guides 18, 22. This open side entrance for loading of pallets 14 is one of the novel aspects of the instant invention. It is to be understood, however, that a worker may also continue to stack pallets by feeding pallets in a direction in parallel to the direction of the conveyor 12.

In operation, a first pallet 14 is positioned on top of the conveyor 12 and oriented so that the edge board or other part of the pallet 14 defining the widthwise dimension is substantially flush against one or both of the first and third guides 18, 22. This can be accomplished using at least two methods. A first method includes orienting the pallet 14 in a manner where it is generally centered on the conveyor 12 so that a lengthwise aspect faces the gate 40 and a widthwise aspect faces the first and third guides 18, 22. If the pallet 14 is not flush against the first or third guide, the pallet 14 is moved forward along the conveyor 12 in a direction toward the gate 40, so that the edge material along the lengthwise dimension comes into contact with the second guide 20. The tapered nature of the second guide 20, via the second vertical surface 30, directs the pallet 14 toward the first guide 18 as the pallet continues toward the gate 40. Eventually, the pallet 14 rides along the length of the second vertical surface 30 until it terminates at the first vertical surface 28. At this point, the pallet 14 continues to be moved forward until it is adjacent to the gate 40 in the closed position. Because the pallet 14 has been moved forward so that the lengthwise aspect is adjacent to the gate 40, the wedging action of the guides 18, 20 is operative to align the widthwise aspect of the pallet 14 substantially parallel to the backstop 26. Further pallets may be likewise stacked upon the first pallet 14 and aligned in similar fashion.

Alternatively, a pallet 14 may be generally centered on the conveyor and oriented so the lengthwise portion faces the gate 40 and the widthwise portion faces the first and second guides 18, 20. If the pallet 14 is not generally flush with at least one of the first and third guides 18, 22, the pallet is horizontally repositioned manually against at least one of the first and third guides 18, 22. While maintaining this generally flush position, the pallet 14 is moved forward toward the gate 40 and eventually abuts the gate. When the pallet 14 abuts the gate 40, a widthwise aspect of the pallet is aligned with the backstop 26 and a lengthwise aspect is aligned with the gate 40. Further pallets may be likewise stacked upon the first pallet 14 and aligned in a similar fashion.

Alternate methods of operation may include simply stacking pallets 14 one on top of another to establish a jumbled stack, thereafter aligning the widthwise and lengthwise portions by moving individual pallets within the stack against the guides 18, 20, 22. A further alternate method might include aligning the widthwise dimension of the entire stack, followed by moving the stack toward and into contact with the gate 40 to align the lengthwise portions of each of the pallets 14. No matter what method is utilized, the guides 18, 20, 22 cooperate to provide a frame into which empty pallets 14 may be regularly stacked.

In any event, the orientation of the pallet stack is relatively uniform in the vertical directions along the lengthwise and widthwise aspects when using the exemplary keeper 10. After the stack has been vertically aligned, the actuator 46 is repositioned out of the line of travel of the gate 40, thereby allowing the gate 40 to pivot to the open position when a forward force is applied to the first vertical surface 42. In this exemplary embodiment, a forward force is applied to the first vertical surface 42 in the form of momentum by the lengthwise aspect of the pallet stack being repositioned along the conveyor and egressing from the keeper 10. Those of ordinary skill will readily understand that the actuator 46 may include a swivel mount to positively reposition the gate 40 from an open position to a closed position and vice versa. Moreover, it is also within the scope of the invention to utilize non-manually repositioned mechanical means to positively reposition the gate 40 from an open position to a closed position and vice versa. Examples include pneumatic or hydraulic cylinders, electromechanical actuators, or toggling eccentric levers.

Fabrication of the first exemplary pallet keeper 10 includes shaping a first guide 18 from a 3/16″ steel plate into a block C-shape. The first guide 18 includes the backstop 26 that faces an interior loading area of the pallet keeper 10. Two wings 52, 54 extend from the vertical ends of the backstop 26 and away from the interior loading area. Each wing 52, 54 is generally perpendicular to the backstop 26 and extends 49/16″ away from the backstop 26 along the entire vertical distance of the backstop 26. A top plate 56 and base plate 58 are mounted across the top and bottom of the backstop 26 to tie the wings 52, 54 together. The base plate 58 also includes three holes 60 adapted to receive permanent fasteners to mount the first guide 18 to the floor of a building.

Two actuator brackets 62 are mounted to the opposite side of the backstop 26. Each actuator bracket 62 includes a 1″ hole that is horizontally aligned with notches 66 cut out of each wing 52, 54 approximately 42″ from the base plate 58. Two additional 1″ notches 68 are cut out of the second wing 54 approximately 12″ and 72″ from the top plate 56, with each notch 68 accommodating a gate bracket 80.

The 15/16″ diameter actuator bar 46 traverses the hole of each actuator bracket 62 and extends longitudinally through the notches 66. A circumferential catch 72 is mounted to the actuator bar 46 between the brackets 62 to limit the travel of the bar to a predetermined incremental distance between the brackets 62. One end 48 of the bar 46 is tapered at an angle, while the opposing end of the bar is bent at a right angle to provide the handle 50. The overall length of the bar 46 may be varied, but for purposes of the instant explanation the bar 46 is 48″ long.

It is also within the scope of the invention that each actuator bracket 62 house bearings (not shown) that circumferentially receive the bar 46 to allow traversal through the bracket 62.

As discussed previously, the second wing 54 includes two 1″ notches 68 approximately 12″ and 72″ from the top plate 56. Each of these notches 68 is traversed by a gate bracket 80 mounted to the backside of the backstop 26. Each gate bracket 80 includes a hole that receives a gate pin 84 allowing the gate 40 to pivot with respect to the first guide 18. The through hole of each gate bracket 80 is sized slightly larger than the diameter of the gate pin 84 and, for purposes of explanation, the hole is 33/32″ in diameter and the gate pin 84 is 1″ in diameter. The gate 40 includes a linear piece of angle iron with segments 42, 44 extending 5″ from the common axis of the gate. Each gate bracket 80 extends outward toward the gate 40 with one of the segments 42 of the gate 40 facing the second guide 20 in the open position, and a second segment 44 of the gate 40 facing the first guide 18 in the open position.

Two sets of bracing brackets 90, 92 are also mounted to the backside of the backstop 26. Each bracket includes a series of vertically spaced holes or slots 96. The first set of bracing brackets 90 is approximately 12″ long and is mounted to the backside of the backstop 26 approximately 52″ from the base plate 58 of the first guide 18. The second set of bracing brackets 92 is approximately 12″ long and is also mounted to the backside of the backstop 26 approximately 30″ from the base plate 58 of the first guide 18.

A stabilizing brace 98 is mounted to the first guide 18 using one of the bracing brackets 90, 92. The stabilizing brace 98 includes a 5/4″ rectangular tube 100 pivotally mounted to a foot 102 that is adapted to be mounted to the floor using a series of fasteners, such as bolts. Depending upon the floor space available for installation of the pallet keeper 10, the foot 102 may be positioned closer to or further away from the first guide 18. To accommodate for these variable distances, the upper end of the tube 100 is repositionably mounted to one of the bracing brackets 90, 92 using repositionable fasteners, such as bolts. Two aligned holes backset 1″ from the upper end of the tube 100 receive the repositionable fasteners that are aligned with corresponding holes or slots 96 through one of the bracing brackets 90, 92. The brackets 90, 92 may be fabricated to include predetermined incrementally spaced holes 96 vertically offset 21/16″ from one another in order to allow the upper end of the tube 100 to be vertically repositioned and thereby correspondingly accommodate for shorter or longer distances that the foot 102 may be mounted from the guide 18.

It is also within the scope of the invention that the brackets 90, 92 include a single oblong vertical hole to accommodate an increased range of distances between the foot 102 and guide 18. For example, the distance between the foot 102 and the guide 18 may not allow the holes within the upper end of the tube 100 to align with a set of holes 96 within one of the brackets 90, 92. In such an instance, a continuous vertical hole would accommodate such a position, whereas a set of distinct vertical holes spaced apart may not.

Referencing FIGS. 1-6, the third guide 22 includes an inward surface 110 that is generally aligned with the inward elongated surface 26 of the first guide 18 so as to lie along the same plane. The inward surface 110 comprises a 3″ wide segment of a rectangular tube that extends approximately 84″ from the floor. The base of the tube is mounted to a foot 112 that comprises a 3″×8″ plate and two triangular segments having 8″ legs. One of the legs of each triangular segment is welded to a rear face 114 of the rectangular tube 22, with a corresponding leg of each triangular segment being welded to the plate. The plate includes through holes adapted to receive a fastener, such as a bolt, in order to mount the guide 22 to the floor.

A cross brace 116 is mounted to the first and third guides 18, 22 in order to tie the guides together. The cross brace 116 is mounted to the first guide using a 3″×7½″ bracket 118 fabricated from ¼″ metal plate material. Two through holes in the bracket 118 are adapted to receive fasteners that are received within corresponding holes of the second wing 52 of the first guide 18. An angle iron member 120 is welded at one end to the bracket 118 and extends away from the bracket a predetermined distance, for example 19″. The widths of each segment of the angle iron member 120 are 2″, with one of the segments including a through hole adapted to receive a fastener to mount the opposing end to the backside of the third guide 22.

The second guide 20 is horizontally spaced from the first guide 18 a predetermined distance to approximate the width of a standard pallet 14. In this exemplary embodiment, the distance between the first guide 18 and the second guide 20 is 40¾″. The second guide 20 includes two primary exposed surfaces 28, 30 that are adapted to be contacted by one or more pallets during the stacking operation. The primary surfaces 28, 30 are formed by shaping a single ¼″ metal plate material so that the first vertical surface 28 is 3″ wide and 84″ tall and angled with respect to the second vertical surface 30 approximately 30°. The second vertical surface 30 is 8″ wide and 84″ tall, however, those of ordinary skill will readily understand that angles other than 30° may be used, thereby impacting on the width of the second vertical surface 30. As discussed previously, the angled nature of the second guide 20 provides a taper to direct pallets 14 toward the first guide 18 as the pallets are moved along the second vertical surface 30 toward the first vertical surface 28.

The second guide 20 also includes a rear surface 34 generally perpendicular to the first vertical surface 28. The rear surface 34 is also fabricated from the single ¼″ metal plate material and is approximately 3″ wide. The rear surface 34 includes a through hole that is adapted to be aligned with a through hole at a corresponding end of the crossbar 24 to receive a fastener, such as a bolt, to mount the crossbar 24 the second guide 20, thus tying the first guide 18 to the second guide 20. Opposing base plates 124 are mounted to the ends of the surfaces 28, 30, 34, with the bottom base plate including multiple through holes adapted to receive fasteners to mount the second guide 20 to the floor.

It is also within the scope of the present invention to outfit the keeper 10 with hardware facilitating portability within a building or storage facility. In an alternate exemplary embodiment, the keeper 10 includes retractable wheels (not shown) mounted to the first, second, and third guides 18, 20, 22.

It is also within the scope of the present invention to outfit the first and third guides 18, 22 with a plurality of horizontal ribs that interpose the guides 18, 20 in order to close off the opening therebetween. Exemplary ribs would face the second guide 20 and cooperate with the surfaces of the guides 18, 22 to define a vertical plane against which pallets may be stacked.

It is further within the scope of the invention that one or more of the guides 18, 20, 22 include rollers vertically oriented to aid in the “push through” alignment of the empty pallets similar to that of the rollers of the conveyor 12 to facilitate ease of egress of the stacked pallets 14 from the pallet keeper 10.

It is further within the scope of the invention that one or more of the guides 18, 20, 22 are repeatably oriented on a carousel (not shown) to enable stacking of pallets and rotation of the carousel to enable discharging of the stacked pallets. In exemplary form, the carousel includes four bays for stacking of pallets, with each bay including one or more of the guides 18, 20, 22 to comprise at least an L-shaped receiver against which pallets may be vertically stacked. In such an embodiment, the bays may be consecutively loaded or alternatively loaded, with at least one bay retaining a stack of pallets while another bay is accommodating the stacking of pallets. Those skilled in the art would readily be able to construct such an embodiment using the instant disclosure.

It should also be noted, however, that the exemplary embodiments of the present invention do not require utilization of a conveyor. For example, the pallets could simply be stacked on the floor of a facility or on the base of a carousel and allow for the withdrawal of one or more stacked pallets from the exemplary keepers of the present invention.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A pallet cuber for vertically aligning and stacking empty pallets comprising:
a primary guide extending vertically and horizontally in a first X-Y plane comprising an X-axis and a Y-axis, the primary guide vertically extending at least to a height of four flat lying pallets stacked upon one another; and
a barrier extending vertically and lengthwise in a Y-Z plane, comprising a Z-axis and the Y-axis, that is perpendicular to the first X-Y plane, the barrier being spaced apart from the primary guide a distance less than a length of a pallet and vertically extending at least to the height of four flat lying pallets stacked upon one another, the barrier being repositionable between a retaining position and an egress position, wherein the retaining position inhibits a pallet from traveling beyond the barrier while traveling along the primary guide in a first direction along the X axis in an X-Z plane, and wherein the egress position allows the pallet to travel beyond the barrier while traveling along the primary guide in the first direction.

2. The pallet cuber of claim 1, wherein:
the primary guide includes a first guide and a second guide, where the first guide is spaced from the second guide along the X-axis within the X-Y plane; and
the barrier is repositionably mounted to the first guide.

3. The pallet cuber of claim 1, further comprising an actuator operative to direct the repositioning of the barrier from at least one of the retaining position to the egress position, and the egress position to the retaining position, wherein the barrier is at least one of slidably repositionable and rotatably repositionable with respect to the primary guide.

4. The pallet cuber of claim 1, wherein the barrier and the primary guide cooperate to provide a block L-shaped pallet receiver when the barrier is in the retaining position.

5. The pallet cuber of claim 1, further comprising a secondary guide spaced apart from the primary guide and extending vertically and horizontally in a second X-Y plane, spaced apart from the first X-Y plane along the Z-axis.

6. The pallet cuber of claim 5, wherein the secondary guide, barrier, and primary guide cooperate to provide a block U-shaped pallet receiver when the barrier is in the retaining position.

7. The pallet cuber of claim 1, further comprising a conveyor to allow the pallet to be conveyed along the X-axis within the X-Z plane, wherein the bed of the conveyor is generally perpendicular to the primary guide and generally perpendicular to the barrier.

8. A pallet cuber for vertically aligning and stacking empty pallets comprising:
a first guide including an exposed surface facing in a first direction; and
a barrier repositionable between a retaining position and an egress position, the barrier including a stop cooperating with the exposed surface of the first guide to provide a pallet receiver while the barrier is in the retaining position, the pallet receiver provides a backstop used to vertically align a plurality of flat-lying pallets in widthwise and lengthwise directions, where the barrier is repositionable from the retaining position to the egress position to permit passage of the plurality of flat-lying pallets beyond the barrier.

9. The pallet cuber of claim 8, further comprising a conveyor, wherein:
the conveyor extends adjacent to the first guide; and
a bed of the conveyor is perpendicular to the stop of the barrier in the retaining position.

10. The pallet cuber of claim 8, further comprising a second guide spaced a first horizontal distance from the first guide, the second guide including a corresponding exposed surface facing in a second direction, generally opposite the first direction, the first and second guides cooperating to define an opening through which the plurality of flat-lying pallets pass when the barrier is in the egress position.

11. The pallet cuber of claim 10, further comprising a supplemental guide including a surface facing in the first direction, where the surface of the supplemental guide cooperates with the exposed surface of the first guide to define a vertically oriented plane normal to a surface upon which the plurality of flat-lying pallets lie, wherein the first guide, the second guide, and the supplemental guide are arranged in a right triangular orientation.

12. The pallet cuber of claim 11, further comprising a conveyor, wherein:
the conveyor extends along to the first guide; and
the surface upon which the plurality of flat-lying pallets lie includes a bed of the conveyor, where the bed is perpendicular to the stop of the barrier in the retaining position.

13. The pallet cuber of claim 8, wherein:
the barrier includes a corresponding exposed surface facing in a second direction, generally opposite the first direction, when the barrier is in the retaining position and spaced a first horizontal distance from the first guide; and
the barrier is pivotally repositionable to orient the barrier between the retaining position and the egress position.

14. The pallet cuber of claim 8, further comprising a supplemental guide including a surface facing in the first direction, where the surface of the supplemental guide cooperates with the exposed surface of the first guide to define vertically oriented plane normal to a surface upon which the plurality of flat-lying pallets lie, wherein the first guide, stop, and supplemental guide are arranged in a right triangular manner while the barrier is in the retaining position, and wherein the first guide, stop, and supplemental guide are arranged in a co-linear manner while the barrier is in the egress position.

15. The pallet cuber of claim 8, further comprising a conveyor, wherein:
the conveyor extends adjacent to the first guide; and
a bed of the conveyor is perpendicular to the stop of the barrier in the retaining position.

16. A pallet keeper comprising:
a first obstruction providing a normal surface closing a first side of the pallet keeper to inhibit loading of empty pallets from the first side while the pallets are lying flat; and
a gate repositionable between a closed position and an open position, the closed position orienting the gate in a manner generally perpendicular to the normal surface of the first obstruction and closing a second side of the pallet keeper to inhibit loading empty pallets from the second side when the empty pallets are lying flat, where the first side is generally perpendicular to the second side;
wherein the pallet keeper is open on at least a third side and a fourth side to allow empty pallets to be loaded and vertically stacked, where the third side is parallel to and opposite from the first side, and where the fourth side is parallel to and opposite the fourth side.

17. The pallet keeper of claim 16, further comprising a conveyor traversing the first guide and second guide, with a length of the conveyor running substantially along the first obstruction.

18. A method of cubing pallets comprising:
orienting a pallet stacking jig in proximity to a conveyor in a closed position, the pallet stacking jig including at least two obstacles operative to vertically align first sides of a plurality of pallets and vertically align second sides of the plurality of pallets, where the first sides are generally perpendicular to the second sides, and where the first sides are generally uniform in length and the second sides are generally uniform in length;
positioning a pallet so that a first side of the pallet is substantially parallel to a first obstacle of the pallet staking jig and positioning the pallet so that a second side of the pallet is substantially parallel to a second obstacle of the pallet staking jig;
repeating the act of positioning the pallet to stack the plurality of pallets; and
conveying a plurality of stacked pallets downstream from the pallet staking jig.

19. The method of claim 18, wherein:
the act of positioning the pallet includes conveying the pallet along the conveyor in a first direction; and
the act of conveying the plurality of stacked pallets downstream from the pallet staking jig is in the first direction.

20. The method of claim 18, wherein:
the act of positioning the pallet includes conveying the pallet along the conveyor in a first direction; and
the act of conveying the plurality of stacked pallets downstream from the pallet staking jig is in a second direction perpendicular to the first direction.

21. A pallet keeper comprising:
a first obstruction providing a normal surface inhibiting the loading of a flat lying pallet from a first side of the pallet keeper;
a second obstruction mounted to the first obstruction and providing a normal surface inhibiting the loading of the flat lying pallet from a second side of the pallet keeper, where the first and second obstructions cooperate to provide a pallet stack receiver that extends vertically to align a stack of pallets along at least two sides of the pallets; and
an upright support about which the pallet stack receiver horizontally pivots between a loading position and an unloading position.
